(19) United States
(12) Patent Application Publication
(10) Pub. No.: US 2018/0250575 A1
(43) Pub. Date: Sep. 6, 2018

(54) GAMES

(71) Applicant: Christian Nevada DEVAUX, Datchet (GB)

(72) Inventor: Christian Nevada DEVAUX, Datchet (GB)

(21) Appl. No.: 15/508,818

(22) PCT Filed: Sep. 4, 2015
(86) PCT No.: PCT/IB2015/056773

§ 371 Date: Mar. 3, 2017

(30) Foreign Application Priority Data
Sep. 6, 2014 (GB) 1415795.2

(51) Int. Cl. A63B 71/06; A63F 13/245

(52) U.S. Cl. CPC A63B 71/0619; A63F 13/245; A63F 2250/495; A63B 2071/0661; A63F 2300/8005

(57) ABSTRACT

Apparatus for use in a game of tag (or variations of this, e.g. a variation of manhunt) that determines the length of period a player is Tag (or a value dependent upon this length) for each of a plurality of such periods, preferably aggregating these periods (or values) for players and/or for teams and displaying results centrally and using touch-sensitive means to detect touching, and a corresponding computer game. The touch-sensitive means may comprise sensing and indicating means carried by one player to sense and indicate a first touching of that player and to sense a next touching by that player of another player (which two touchings define a period of Tag of said one player) by cooperation with similar means carried by that other player, which means may comprise a signal generator, generating a different signal while a player is Tag.

### FIELD OF THE INVENTION

This invention relates to games.

### BACKGROUND

In the traditional game of tag, a first player is given a status of Tag and tries to touch a second player. The status of Tag is transferred from the first player to the second player by the act of the first player touching the second player. There are also various games called manhunt, being variants of the traditional game of tag, in some of which there are more than one player with the status of Tag (or hunter) trying to touch at least one other player.

### THE INVENTION

The present inventor has realised that the games can be made more interesting, especially as spectator games, by introducing scoring. He makes the score depend upon the length of time that players have the status of Tag and provides apparatus to do this. Preferably, his apparatus is constructed and arranged to aggregate such times. More particularly, according to one aspect of the invention, he provides:

Apparatus, for use in a game of tag, constructed and arranged to be responsive to the starting and ending of a period of time that a player has the status of Tag so as to determine the times of the start and end of that period and to associate these times to enable a determination of a value which is the length of that period or is a quantity dependent upon that length, for each of a plurality of such periods.

Thus, “the status of Tag” denotes any state of a player that is time-limited and detectable in the sense that actions associated with the start and end times of that state can be responded to by the apparatus.

The plurality of periods may be for a single player, in which case one embodiment of the invention could be apparatus carried by the player; or the plurality of periods could be for a plurality of players, in which case one embodiment of the invention could be apparatus which has a central unit in communication with the plurality of players.

Apparatus embodying the invention may be constructed and arranged to be carried by a player, and such as to transmit said data to a central unit at the end of a game and/or at one or more intermediate times which may be preset, or controlled by the central unit, e.g. when the apparatus is interrogated by the central unit, or consequent upon parameters of the game, e.g. consequent upon the ending of a period of tag status, e.g. for that player or another, which stored data may for example comprise data as to times of starting and/or ending of periods of tag status or values being the length of such periods or being quantities dependent upon such lengths or aggregates of such values, with or without the ID of the player.

Where there is ‘touching’ to start or end a tag period, actual touching is highly important in order to maintain the pace of the game as ‘fast and furious’. Sometimes a tag period may be started by an external non-touching act, e.g. at the start of the game, or may be ended by an external non-touching act, e.g. at the end of a game, e.g. by timeout.

While scoring may simply be dependent upon the length of time a player is Tag, the dependence may not be linear, e.g. the rate of scoring with the timing may decelerate (or accelerate) the longer the player is Tag; and the score may depend upon other factors, e.g. as exemplified below, e.g. historical or skill factors. Preferably, the score depends upon the aggregate of the periods of time that a player is Tag. Usually, the winner will be the player that has been Tag for the shortest aggregate time, possibly (in a variant game) excluding any players that have never been Tag. This requires means to evaluate the time that a player is Tag, preferably means to evaluate the duration of each occasion the player is Tag, e.g. means to time when a player starts and finishes being Tag on any one occasion. Such means may not note or measure the time as such but may e.g. evaluate the time, e.g. by an integrating method, e.g. as the charge on a capacitor that is continuously being charged/discharged (possibly not linearly) while the player is Tag. There may be respective score-evaluating means for each player, e.g. carried by each player. The scores may be consolidated and/or compared at the end of a game to determine the winner. Preferably, the evaluation, e.g. charging, on each said occasion starts or continues when a player is touched and stops or pauses when that player touches another player. The indication of touching may be by an electrostatic method, e.g. the players running in insulating (e.g. rubber) shoes, and carrying an electrostatic charge whereby upon their touching another player the charge of each suddenly changes and a detector carried by each player detects such changes of charge and starts or pauses respectively the aforementioned charging of each player's scoring capacitor. In addition, or alternatively, there may be central score evaluation, e.g. detection of the time events when each player starts and stops being Tag on any occasion. This would be used in conjunction with means to identify the player/s concerned. See below concerning teams. Preferably, the changeover of Tag from one player to another can then serve a double function as being a single time event which is both a stop for one player and a start for another player. The means to detect a touch may be remote, or may be worn or carried by each player, e.g. bibs one worn by each player and sensitive to being touched, as exemplified below. The touching event need be noted only in conjunction with the identity of the new Tag, since the previous Tag has already been identified. For this purpose, each player may carry a transmitter which, upon the player being touched (on the bib, or elsewhere, e.g. another designated place), will transmit the identity of the new Tag, and receiving means (which may be central for all the players and/or may be carried by individual players) can note this event and use it to pause the timing evaluation of the previous Tag and also to start or continue timing evaluation for the new Tag. The transmission mode may be any non-wired connection, e.g. by light, radio or ultrasonics. Reception is preferably by a central unit that will evaluate/keep score for each of the players and/or may be effected player-to-player by transmitting and/or receiving means carried by individual players. The central unit may also have transmitting means to transmit any kind of signals to the players, selectively or generally, to specific players (e.g. Tag) or to all players, possibly on different occasions during the game, for example any one or more of: signals to indicate that a touch has been successful (and perhaps that it has been recorded at the central unit); signals to indicate the identity of the touched player and/or the touching player; signals to indicate timing and/or scores; control signals used to control equipment carried by one or more players, e.g. to switch an indicating lamp that indicates that a player is Tag to on, off or intermittent flashing and/or to indicate such equipment that a period of Tag for the appertaining player is now ended. These scores may be put (preferably automatically) onto a public display to enhance the game as a spectator sport. The scoring may additionally depend upon skills, e.g. special moves that a player makes while Tag (or even while not Tag, e.g. while evading the tag and/or in a computerised version of the game), e.g. evaluated automatically or by a panel of judges and fed into the scoring. If there are teams, the identification of the new Tag may be simply of which team, so that “player” should be read as “team”. If there are only two teams, even the team may not need to be identified, since successive tagging events will relate to the two teams alternately in a straightforward game of Tag. In such case, there may be means to prevent a tagging event being signified if a player touches another of the same team, though it may be chosen to have the possibility of passing Tag from one player to another of the same team, e.g. for tactical purposes or to help in case of tiredness. For example, the bib may be associated with means to identify whether the touching player (the Tag) is of the same team, e.g. each player carrying a team-indicating means, e.g. a distinctively-coloured shirt, or a chip (e.g. a smart and/or radio chip) and a proximity device to detect the team of the Tag from the team-indicating means of the Tag. Other aspects of proximity means are discussed below. The device that the player wears does not necessarily need to know which team he is on because the central processor can determine that very easily by just adding up the ‘Tag Times’ of certain players. E.g. if there are 3 people in a team, the central processor just adds together the scores of Player A+Player B+Player C and shows that as Team 1's ‘Tag Time’.

Another variation, invented by the present inventor, is a variation of the game known as Manhunt, and has two teams, A and B. In this, there are usually two phases: in the first phase Team A is the hunting (Tag) team and Team B is the hunted team; in the second phase the roles of the teams are reversed. In the first phase, only one player from Team A and all the players from Team B are on the field; the A player chases the B players until one is caught (touched or tagged). That B player retires from the field and another A player joins the first A player to chase the remaining B players, and so on until all the B players have been caught. When the last one is caught, this ends the first phase. The second phase plays similarly. Scoring depends upon the aggregate or total time taken for each phase. For example, there are thus two time scores and each is allotted to the relevant hunting team, and the team with the lower score wins. (Alternatively, each of the two time scores may be allotted to the relevant hunted team, and the team with the higher score wins.) The time score may be an aggregate of time scores for the team as a whole or for each of the active (Tag) players in the team. For example, the (active) timing for all the hunters on the field stops upon any one hunter touching a hunted player, and in one form of the game timing is restarted by external means (e.g. a referee) when the touched hunted player has moved off the field and one of the hunting team's off-field players has been designated as an active (Tag) player and is ready to join the game. For this purpose, each team's active players may have predefined starting locations, e.g. at opposite ends of the field of play, to which they must return before the play can re-commence. In another form of the game, the off-going (just touched) player has immediately to touch one of the other team's off-field hunting players for that player thus touched to become a new one of that team's hunters, and that act of touching re-commences (active) Tag timing for all of the hunters then on the field. The aggregate may, in a first method, be simply the total active time of the team for a phase. Again, the aggregate may, in a second method, be the total active time for each of the individual players, these totals then being aggregated together. The difference is that if the first hunter took a long time to catch the first hunted player and then all the following hunted players were caught fairly quickly, the score would be lower by the second method than the first method, assuming the same time length for the whole phase by both methods.

Of course, it would be possible for the game to have only a single phase: for example, if the score for the hunting team counts down from an initial value and the score for the hunted team counts up from an initial value, which may for example be negative or zero, or the scores could be vice versa, possibly varying the scores by bonuses or penalties according to other actions by the players, e.g. as discussed herein. For example, if a game is timed for maximum five minutes (300 seconds) and counts one point (up or down) for each two seconds (giving initial values of 150 points for the hunted and zero points for the hunters), without any bonuses or penalties, the single-phase game would be won by the hunted if it lasted longer than halfway, or by the hunters if it terminated earlier by all of the hunted being tagged/caught; and if the game is played to a finish (until the last hunted player is touched) the difference in scores could indicate how much better one team is than the other.

Many variations of the inventive game and its rules will be apparent to those skilled in the art, possibly taking into account variations in games already known.

Another aspect of the invention provides means to facilitate scoring in a game of tag in dependence upon the duration for which each player is Tag, e.g. from one touching to the next touching, for example any article worn or carried by a player, e.g: a bib, possibly comprising a patch of material on the player's back and/or front; a tunic; a belt; any of these possibly with a button or marked pressure area/s to be touched. The term “article” as used herein may refer to a plurality of pieces of equipment carried by a player and inter-communicating by wire or non-wired connection.

Another aspect of the invention provides means to evaluate scoring in a game of tag in dependence upon the duration for which each player is Tag, e.g. by processing at a central receiver and computer.

Another aspect of the invention provides a computer game of Tag which involves scoring dependent upon timing, e.g. between touches of avatars on a screen whose positions and actions are controlled by respective players. This may have any one or more of the further features mentioned herein.

Another aspect of the invention provides a computer program or programming means, constructed and arranged to program a computer to operate such a game of Tag.

Another aspect of the invention provides apparatus providing a game of Tag which involves scoring dependent upon timing, e.g. between touches of physical avatars on a playing field in the form of robots whose positions and actions are remotely controlled by respective players.

Another aspect of the invention provides computer apparatus or programme, for simulating a game of Tag, comprising programme means adapted and/or arranged:
to provide a plurality of avatars movable under the control of respective players of the game,
to designate, mark or enable, one of the avatars, herein called Tag,
to detect a first touching when Tag touches another avatar, herein called Second Tag,
to detect a second touching when said Second Tag next touches another avatar,
to respond to the second touching to transfer the Tag designation to said other avatar,
to respond to said first touching and said second touching to determine the period between said first touching and said second touching (being the time said Second Tag avatar is Tag), and
to evaluate a score dependent upon said period.

Such computer apparatus or programme may be adapted and/or arranged to aggregate said scores for an avatar or for a plurality of avatars.

Another aspect of the invention provides apparatus, for use in a game of tag, constructed and arranged to be responsive to the starting and ending of a period of time that a player has the status of Tag so as to determine the times of the start and end of that period and to associate these times to enable a determination of a value which is the length of that period or is a quantity dependent upon that length, for each of a plurality of such periods, wherein “the status of Tag” denotes any state of a player that is time-limited and detectable in the sense that actions associated with the start and end times of that state can be responded to by the apparatus.

Such apparatus may have any one or more of the following features:
means constructed and arranged to determine said value;
the apparatus is adapted to be carried by a player;
comprising timing means responsive to a first touching by a first player of a second player to determine a time for said first touching and responsive to a second touching by the second player of another player to determine a time for said second touching, the apparatus comprising means constructed and arranged to associate the two determinations to enable the determination of a value which is the length of the period between said first and second touchings or is a quantity dependent upon such length;
comprising sensing and indicating means adapted to sense and indicate a said first touching of said second player and to cooperate with similar means carried by said other player (i.e. sensing and indicating means adapted to sense and indicate a said first touching of said other player) to sense a said second touching by said second player;
in which said sensing and indicating means comprise a signal generator constructed and arranged to produce a first signal before said first touching and a different second signal after said first touching and in response to said first touching and to produce said first signal again after said second touching and in response to said second touching the touching may be on a conductive tunic;
comprising means constructed and arranged to produce an aggregate of a plurality of such values for a player or for a group of players;
comprising display means constructed and arranged to display any one or more of said values and/or aggregates, as the case may be;
comprising display means constructed and arranged to display a plurality of said aggregates;
in which the display means are constructed and arranged to display said aggregates in the form of a bar chart (e.g. with a bar for each player or team).

Another aspect of the invention provides apparatus for use in a game of tag, comprising timing means responsive to an initiating event to determine an initiating time for a timing period for a player and responsive to a terminating event to determine a terminating time for that time period for that player, at least one of which events is a touching of or by that player by or of another player, the apparatus comprising means constructed and arranged to associate the two determinations to enable the determination of a value which is the length of said period or is a quantity dependent on such length, and the apparatus comprising means constructed and arranged to aggregate a plurality of such values for a player or for a group of players.

Another aspect of the invention provides apparatus for use in a game of tag, comprising timing means responsive to a first touching by a first player of a second player to determine a time for said first touching and responsive to a second touching by the second player of another player to determine a time for said second touching, the apparatus comprising means constructed and arranged to associate the two determinations to enable the determination of a value which is the length of the period between said first and second touchings or is a quantity dependent upon such length.

Another aspect of the invention provides a game of tag played on a computer which comprises means to score in dependence upon timing between touches of avatars on a screen whose positions and actions are controlled by respective players (considered individually or as team play).

Another aspect of the invention provides a computer program or programming means, constructed and arranged to program a computer to provide a game of tag as mentioned in the last preceding paragraph.

Another aspect of the invention provides apparatus providing a game of tag, constructed and arranged to score in dependence upon timing between touches between physical avatars on a playing field whose positions and actions are remotely controlled by respective players.

Another aspect of the invention provides programming means constructed and arranged for programming a computer to cause the computer to provide an on-screen or physical avatar version of a game of tag, the game being arranged for activity of the on-screen or physical avatars to be under the control of players, and for at least some of the avatars to undergo a period of tag status which is started and/or ended in consequence of one avatar touching another, such that the game includes the features of:
detecting the start and end of a plurality of periods of tag status of on-screen or physical avatars; and
determining for each such period a value which is the length of that period or is a quantity dependent upon that length.

Such programming means may be constructed and arranged for programming the computer to cause the computer to provide said game with the feature of aggregating such values for an avatar or for a plurality of avatars.

Another aspect of the invention provides a computer programmed by any such programming means to provide said game of tag. Another aspect of the invention provides apparatus comprising such a computer and control means constructed and arranged for players to control the avatars.

Another aspect of the invention provides a game of tag in which scoring is made in dependence upon timing of the lengths of periods for which players remain Tag (and e.g. upon possibly skill). Another aspect of the invention provides such a game in which scoring is made up of aggregates of values depending upon the lengths of periods for which players remain tag.

Another aspect of the invention provides a variation of the game of manhunt on a field of play, comprising two teams, one of chasers, some active and some quiescent, one of hunted players, in which an active chaser chases and touches one of the hunted players who then has to leave the field of play, in consequence of which touching one of the quiescent chasers becomes another active chaser, the game continuing until all of the hunted players have been touched, with scoring being in dependence on the lengths of times of periods for which a player is an active chaser, for at least two such periods (which need not be for the same player).

Another aspect of the invention provides apparatus for use in a game of tag, comprising timing means constructed and arranged to determine a value dependent upon how long a player remains as Tag, i.e. between being touched and in turn next touching another player.

The apparatus is essentially for use in a game in which players are in a state of Tag on a succession of occasions and the apparatus just described is for an intermediate Tag period (i.e. not the first Tag period and not the last Tag period) and in its simplest form is an apparatus for timing the length of period that a player has the status of Tag (i.e. from being touched by a player until next touching another player). To this can be added a feature suitable for timing a first Tag period (initiated by an event which is not touching, e.g. by an external signal which starts the game and possibly selects which player is to be Tag first) and/or a feature suitable for timing a last Tag period (terminated by an event which is not touching, e.g. preset timing of the end of a game). Such additional feature/s can be included in apparatus for a game in which there is timing of a plurality of tagging periods, for example being additional features to the apparatus described above.

Another aspect of the invention provides apparatus for use in a game of tag, comprising means constructed and arranged to determine an aggregate of values dependent upon how long one or more players remain as Tag, i.e. between being touched and in turn next touching another player.

Another aspect of the invention provides apparatus for use in a game of tag, comprising timing means responsive to an initiating event to determine an initiating time for a timing period for a player and responsive to a terminating event to determine a terminating time for that time period for that player, at least one of which events is a touching of or by that player by or of another player, the apparatus comprising means constructed and arranged to associate the two determinations to enable the determination of a value which is the length of said period or is a quantity dependent on such length, and the apparatus comprising means constructed and arranged to aggregate a plurality of such values for a player or for a group of players.

Another aspect of the invention provides apparatus for use in a game of tag, comprising means responsive to an initiating event which initiates a period of tag for a player and responsive to a terminating event in which that player touches another player to terminate such period to determine a value which is the length of such period or a quantity dependent upon such length, and to aggregate such values for a player or for a group of players.

Another aspect of the invention provides apparatus for use in a game of tag, comprising means responsive to an initiating event in which a player is touched by another player to initiate a period of tag for the touched player and responsive to a terminating event to terminate such period to determine a value which is the length of such period or a quantity dependent upon such length, and to aggregate such values for a player or for a group of players.

Another aspect of the invention provides apparatus comprising display means constructed and arranged to display such values and/or aggregates as the case may be for a plurality of players in association with IDs of the respective players and/or IDs of a plurality of teams comprising the players.

Another aspect of the invention provides a game of tag or of a variation of tag in which values representing or dependent upon the lengths of periods for which players remain tag are detected, and preferably aggregated.

The apparatus described above may consist of an article worn by a player and provided with timing means responsive to a first event comprising the player being touched by another player to record and timestamp (to determine a time for) that first event and responsive to a second event comprising the touched player then touching another player to record and timestamp (to determine a time for) that second event. The two determinations are associated by both being carried by said touched player and thus enable the determination of a value which is the length of the period between said first and second events or as a quantity dependent upon such length. The two timestamps may be used immediately to determine such value or may be stored for use later to determine such value. The two timestamps may be transmitted immediately or later to a central unit to enable the central unit to determine such value; and/or the article may be provided with means to determine such value. The article may comprise means to aggregate a plurality of such values for the touched player; and may have means to transmit to the central unit such aggregate as it changes, or as a final aggregate; and/or the central unit may be provided with means to aggregate a plurality of such values for the touched player or for a group of such players, e.g. a team. The apparatuses (said articles) of such players may inter-communicate directly, e.g. to notify each player of his current ordinal position among the aggregates of various players, or simply to notify a player when he has made an effective touching of the next player, e.g. by a ping in an earphone triggered by a signal from said next player when touched. The central unit may comprise display means to display such aggregates, as they change, or as final aggregates. The apparatus may be adapted to include in the aggregates values for Tag periods that start or end with a non-touching event.

Further aspects and preferred or exemplary features of the invention may be as any of the following:
(According to an aspect of the invention) means to enable scoring in a game of tag in dependence upon the time duration that a player remains Tag.
comprising means constructed and arranged to detect the occurrence of a tagging event, being defined as an event at which tag passes from a first player who is Tag until the event to a second player who thereupon becomes Tag instead (usually by an act of touching), and provide a signal to indicate the detection. (The term “detect” normally refers only to the case of immediate detection but, as the term is used in the present description and claims, it includes also the possibly more unusual case of finding out, subsequent to the event, when the event occurred.)
in which the means to detect when a tagging event occurs comprise an article of wear.
said article of wear is touch-sensitive.
said article of wear comprises a touch-sensitive bib.
comprising means to ascertain and indicate the identity of the new Tag and/or, if the players are in designated teams, the team identity of the new Tag.
comprising means constructed and arranged to ascertain and indicate the team and/or individual identity of the touching (previous) Tag. (The scoring enabling means may comprise means to indicate and/or display any such identity/ies, and may be passive or active. Such indicating means may comprise an RFID device. For example, each player may have an RFID device, which is normally thought of as a device whose ID can be read from a few metres away (or closer) but it might be a mobile phone or GSM unit. The system can use the same encoded RF signal normally transmitted from the GSM/RF transmitter/receiver. The system may use GPI (global positioning indication) or other means to indicate a player's position, and tracking to maintain a record of each player's ID, possibly including such additional information as distance covered, heart rate, top speed, average speed, acceleration, as well as further information to display the player's most favoured positions on the court, or automatic facial recognition, possibly in conjunction with tracking for the same purpose.)
comprising proximity means constructed and arranged to be carried by a player and adapted and/or arranged to detect that another player is proximate when a touching event occurs (i.e. that this is not an accidental or spurious touch, that is not by a player). (Said proximity means may be adapted and/or arranged to ascertain that said proximate player is Tag, i.e. that this is not an accidental or spurious touch by another player who specifically is not Tag. Again, said proximity means may be adapted and/or arranged to ascertain the team and/or identity of the touching and/or intended Tag. Preferably, the proximity means comprise an authorisation device and/or ID device to be carried by one player and a proximity detector to be carried by another player to detect the proximity of said device.)
comprising means constructed and arranged to ensure a predetermined minimum interval before a newly tagged player can pass tag back to the previous player who tagged them. (This interval is to allow the previous player to evade a ‘return tagging’; it may make the game more free-flowing; it would preferably not apply to the newly tagged player transferring tag to any other player at that time.)
comprising means constructed and arranged to evaluate a score in dependence upon the time duration that a player remains Tag. (The term ‘evaluate’ is used as being more comprehensive than ‘measure’, e.g. if the score is to be possibly a non-linear function of the time that a player is Tag. In a simple case, the evaluation is simply measuring (e.g. the allotting of points for) time spent as Tag, and in another case possibly takes into account negative points for skills used. The winner is the player with the lowest, or most negative, score. Although, in a variant game, more akin to football (soccer), possession of the tag for the longest time (highest score) signifies the winner; the Tag tries to retain tag as long as possible, evading other players, losing tag only to the first player that touches the Tag; this variant game, may include any other feature or features mutatis mutandis of the other games of tag described herein, e.g. the special move scoring mentioned next may then be added instead of subtracted.)
comprising means constructed and arranged to aggregate the times and/or scoring evaluations for a player or team (e.g. evaluate the total time that a player or team is Tag by aggregating from a plurality of tagging events). (The term ‘aggregate’ includes the case of the single evaluation if a player is Tag only once, or even the score itself if the player is never tagged. This may arise in a situation where a player is never tagged throughout the duration of the game. The player's ‘aggregate’ score is still applicable, but it will be zero (or possibly negative if the scoring is affected through special moves that are evaluated automatically or by a panel of judges, e.g. as mentioned above. These comments apply equally to the case of an avatar, for which see below.)
comprising means constructed and arranged to transmit information denoting any such detection, time duration, score, aggregate, ID and/or tagging event, as the case may be.
comprising a central receiving means adapted to receive such information.
comprising a central processing means adapted to process such information.
comprising display means constructed and arranged to display an indication of at least the players who have been tagged and the tagging score of each of them. In some embodiments, it is important to note that even the players who have NOT been tagged are still very much part of the game, indeed they may actually be the most skilled players. Therefore, in a possible embodiment the display means are constructed and arranged to display an indication that includes ALL of the players in a game (i.e. those players that HAVE been tagged as well as those players that have NOT been tagged).
in which the display means are constructed and arranged to display the aggregates in a list in order of magnitude.
in which the display means are constructed and arranged to display the aggregates in a list in order from lowest to highest. (The winner is usually the player with the shortest time as Tag, or lowest score, possibly negative, apart from in the case of the variant game as mentioned above.)
(According to another aspect of the invention) means to detect and indicate the time of a tagging event in a game of tag. Such an event may be a tagging touch or other contact-like event, (which may be enhanced by a suitably defined proximity detection detected by suitable proximity means) or a ‘ripcord’ or trigger, e.g. in the case of a variant article of wear having a plurality of tags, any one to be pulled to signify a tagging event. Such means may comprise a touch-sensitive article of wear provided with means to issue a signal indicating the occurrence of the event and the identity of the player wearing the article. A touch-sensitive article for use in embodiments of the invention may have a substantial distributed touch-sensitive area. Said area may be pressure-sensitive, electrostatically sensitive and/or have multiple elements of successively differing (e.g. alternate) polarity or type such that touch of two adjacent elements will cause an indication of touch. A touch-sensitive article for use in embodiments of the invention may be adapted to be worn and touched to signify or ascertain when a tagging event occurs. This may apply not only to bibs but also any other means of temporarily affixing pressure sensitive pads to any part of the body, e.g. by affixing to clothing, by removable bands and/or by belts, by ripcords/tags, or by other means that will be apparent to one skilled in the art.
(According to another aspect of the invention) a modified game of tag in which a score is made in dependence upon the time that a player is Tag.
in which the score is made dependent also upon one or more defined features of skill exhibited by the Tag (or a player evading the Tag). (possibly being made dependent upon degree of skill)
(According to another aspect of the invention) a computer programme for simulating a game of Tag comprising programme means adapted and/or arranged:
   to provide a plurality of avatars movable under the control of respective players of the game,
   to designate, or enable, initially one of the avatars as Tag,
   when Tag touches another avatar, to transfer the Tag designation to the latter, and
   to evaluate a score dependent upon the time an avatar is Tag.
which is adapted and/or arranged to aggregate the time evaluations for an avatar. (The term ‘aggregate’ includes the case of the single evaluation if an avatar is Tag only once, and other circumstances as mentioned above in relation to the term ‘aggregate’.)
which is adapted and/or arranged to display the aggregates in an ordered list.
which is adapted and/or arranged to display the aggregates in a list in order from lowest to highest.
to provide or associate a plurality of said avatars with skill sets (which may differ from one avatar to another).
which is adapted and/or arranged to evaluate a said score dependent also upon one or more defined features of skill.
(According to another aspect of the invention) a computer programme for simulating such a modified game of tag, adapted to provide a plurality of avatars on a screen representing players of the game, adapted to respond to control means to move the avatars on the screen, adapted to ascertain when a designated one of the avatars (herein called the Tag) touches another and thereby transfers the tag to the other, and adapted to time, or otherwise evaluate a score depending upon, the duration that one avatar is Tag until transferring the tag to another avatar.
   Possible Embodiments of the Invention May have any of the Following Features:

### Function

To create an electronic timing system to formalize the game ‘Chase Tag’ (also known as ‘You're it’, ‘Tag, you're it!’, ‘Tag’, ‘Tig’ etc.

### The Game or Sport

### Introduction—

The game requires at least two participants with potentially no upper limit on the number who can take part; however I envisage a maximum of about eight participants in any one game. The participants are contained within a designated playing area of approximately 150 square metres (the size of a tennis court). Each participant wears a bib that wirelessly transfers his or her ‘Tag-Time’ information back to a centralized computer scoreboard.

### General Outline—

The game is essentially about avoiding being ‘The Tag’.

A participant who is ‘The Tag’ will try and chase opponents to pass ‘The Tag’ on to them. This is done simply by touching any of the touch-sensitive bibs worn by all of the opponents.

A participant will either chase opponents while they are ‘The Tag’ or, when they are not ‘The Tag’, (in which case they are an ‘Evader’), they will try and evade participant who is ‘The Tag’,

The amount of time that each player spends as ‘The Tag’ is recorded (in minutes and seconds), and is called the ‘Tag Time’. The winner is the participant with the lowest ‘Tag Time’.

### The Game—

After a 10 second countdown, a bell will sound to indicate the start of the game, which lasts for 5 minutes (300 seconds).

At the start of the game, the computer scoreboard randomly selects one of the participants to be ‘it’, i.e. ‘The Tag’. The selected participant's bib then lights-up (or flashes) and the computer scoreboard begins recording the amount of time that the selected participant remains on ‘it’ (i.e. spends as ‘The Tag’). This is known as their ‘Tag-Time’.

When the initially selected participant (‘The Tag’) touches or tags another participant's bib the computer scoreboard pauses tallying the amount of time that the initial participant has remained on ‘it’ and starts recording the amount of time that the newly selected participant remains on ‘it’ until that participant, in turn, touches or tags another participant.

For the collective benefit of the participants, the referee and the spectators, every time that the ‘it’ or ‘tag’ is transferred to another participant, the computer scoreboard generates an audible sound, e.g. a hooter.

After 5 minutes of open play a bell is sounded to indicate the end of the game. The computer scoreboard will indicate the Tag Times for each participant (i.e. the total amount of time that each participant remained on ‘it’ throughout the 5 minute period).

### The Product

The product comprises three elements;
1. A set of electronic touch-sensitive bibs each of which records the amount of time that its wearer spends on ‘it’.
2. A computer scoreboard that displays the Tag Times for each participant.
3. A PA system integrated into the computer scoreboard that indicates the start and/or end of each game and also whenever the ‘it’ or ‘tag’ is transferred from one participant to the next.
   a. Physical Requirements.
      The bibs should be lightweight, e.g. less than half a kilo, comfortable to wear and allow the user to maintain maximum mobility.
      The bib will have a touch-sensitive pad on the front and back. When either of the touch-sensitive pads are activated, the bib transmits a remote signal to the computer scoreboard recording the amount of time that the bib wearer spends on ‘it’ before another touch sensitive pad on another bib is activated.
      The bib must have the ability to indicate, e.g. light up or flash, in order to allow the competitors to know which competitor is on ‘it’ (i.e. who is the chaser or Tag) and hence who to evade. This is also important in order to keep spectators engaged.
      The computer scoreboard is a straightforward design that simply displays the Tag Time of each participant.
      The computer scoreboard will have a speaker system that allows it to emit a noise to indicate the start and/or end of each game and preferably also whenever the ‘it or ‘tag’ is transferred from one participant to the next.
   b. Performance Requirements
      The computer scoreboard must record time to the accuracy of one tenth of a second.
      It is important that the bibs and the computer scoreboard are able accurately and reliably to transfer wireless time-recording data instantly over the designated playing area.
   c. Operating Environment
      The bib and the computer scoreboard will be intended to operate in an enclosed area of about 150 sq. m (approximate size of a tennis court).
   d. Ergonomics
      It is very important that the design of the bibs does not hamper the running, jumping and free-flowing movement of the participants, and the performance of any special actions for which skill points may be awarded.
   e. Weight
      See ergonomics.
   f. Aesthetics, Appearance & Finish
      Colour, shape and form are secondary to the need of maintaining free-flowing movement throughout the game.
      All bibs must have the ability to indicate the ‘Tag’, preferably by lighting up or flashing. This will occur whenever its wearer (i.e. the chaser) is ‘Tag’ or ‘it’.

### Variations

There are three distinct categories of end user contemplated:
1. Professional—For use in competitions. This is the version outlined above.
2. Semi Pro—To be used by corporate clients and strategic partners—e.g. team-building consultants, HR departments, Leisure Centres or companies, e.g. Laser Quest, Gravity Force, Cross-Fit Games, that provide (usually adult) games for various purposes.
3. Amateur—For retail sale to the general public. Purely for recreational, e.g. garden, use.
   In order to suit the end user and their varying budgets, there may be slight variations in the product itself. These variations are as follows:
Amateur Version—The Professional version of the product will be a touch-sensitive bib, but due to economic constraints, the amateur version could be in belt form, where there will be four ‘push points’, one each on the front, back and sides of the waist area, with perhaps another 2 ‘push points’, e.g. on extension belts, one each on the chest and back area at shoulder level.
Computer Scoreboard—In the amateur and Semi-Pro versions, the computer scoreboard will allow the user to download songs onto a hard drive. Those songs can then be assigned respectively to any number of competitors and can be played during the time that they remain on ‘it’.
Accidental activation of bibs or belts through such actions as collisions or falling over is a concern that needs to be overcome. There are a number of variations that could potentially overcome this problem, such as for instance:
Connected Rods—Having a rod that is held in the hand and connected to the vest (i.e. bib or belt) via a robust cable. Only a touch by the rod of the participant on ‘it’ (i.e. who is ‘Tag’) will activate a successful ‘tag’. This might operate electrostatically, e.g. by discharging to the bib or belt of the next player to signify a successful ‘tag’, with the effect that the touching participant then ceases to be on ‘it’ and the next player then starts to be on ‘it’.
Gloves—Same principle as the rod.
Having a hand-held device such as a rod that is connected to the bib via a cable will hamper movement and make the game less entertaining to watch. Thus another solution could be:
Large buttons or touch pads that require more than just a light touch.
This should eradicate very light touch errors as well as the need for cables and rods, which will improve movement, but it will not eradicate erroneous tags through falls or strong impacts. A much better solution would be:
Proximity Wristbands—The Participants could wear wristbands on each hand that are remotely linked to their bib. Any contact with a bib's touchpad will only activate a successful ‘tag’ if the wristband of the participant being ‘it (Tag)’ is in close proximity (i.e. less than 30, 25, 20, 15, 10 or 5 cm, as desired) to the ‘tagged’ participant's touchpad.
Tag Ripcord—somewhat like in tag rugby, which requires a Velcro™-type tag (one attached by micro-hook-and-eye, or other re-usable fastening, e.g. a clip) to be ripped off e.g. the participant's clothing to signify a ‘tackle’; but in embodiments of the invention every time a tag is pulled off it triggers the ‘clock’ of that participant to start or re-commence timing.
Electrostatic Technology or similar—that causes a small electrical current to pass through the wearer's body (e.g. somewhat like when you test your body-fat index) so that any touches to the skin of any part of the participant's body are picked up, e.g. causing a voltage change that can be detected; e.g. based on the principle that two bodies at different potentials coming into contact will tend to equalise their potential by a small current surge.

Game Variations
Team Game—The game could also be played in teams, with two, three or even 20+ people per team. The principles remain the same i.e. only one person on it at a time, but rather than record individual times, the computer scoreboard only shows the collective Tag Time of the entire team.
Time Reversal—A variant of the game could be to reverse the general aim so that the player with the longest ‘Tag Time’ wins. While a participant is ‘Tag’ he will try to avoid contact with all of the other players who are trying to take the ‘Tag’ away from him.
App—There is also the possibility of introducing an app version using smart phones as a hand held device where the ‘Tag’ can be transferred once it comes into close proximity (predefined how much) to another participating smart phone, preferably in conjunction with touching.

Computer Game—According to embodiments of the invention a game such as ‘Chase Tag’ can be made into a computerised version of the same game. The computerised versions of the game described below include a time-related version, and that element distinguishes it greatly from the playground equivalent.
Accumulator—Another variant version that could be popular for corporate clients and team building events would be a system that splits a group of people/players into two opposing teams of different colours (e.g. red and blue). Each team has a designated ‘Tagger’ who has to try and ‘tag’ as many people on the opposing team as possible (apart from that team's own Tagger), which changes their colour. The winning team is the one with the most dominant colour at the end of a timed game-play. This may be combined with scoring in dependence upon timing of how long players remain tagged, e.g. if a player can be ‘rescued’, after having been tagged, by being tagged again by a member of the player's original team. Other possibilities will be apparent from other descriptions herein.

My concept concerns the use of (recording, indicating and/or scoring in dependence upon) ‘time information’ or ‘time-related information’.

### Chase Tag—You're It!—Computerised Game Version

This is an action chase game where players battle against opponents and the clock to achieve the lowest ‘Tag Time’.

### Introduction

The players are represented by avatars on a screen and the game can be adapted to operate from any joystick, hand-held control, or other control, e.g. by any other part of the body, e.g. by the eyes, e.g. by motion capture.

The game is essentially about avoiding being ‘The Tag’.

When a player is ‘The Tag’ he will try and chase opponents to pass the tag on to them.

A player will either chase opponents while they are ‘The Tag’ or, when they are not ‘The Tag’, they will try and evade ‘The Tag’, in which case they are an ‘Evader’. After a player has transferred the tag, they may later be tagged again.

The aggregate amount of time that each player spends as ‘The Tag’ is recorded (in minutes and seconds), and is called the ‘Tag Time’. The winner is the player with the lowest ‘Tag Time’.

The game lasts for a pre-determined amount of time (usually 3-10 minutes but can be longer or shorter) and is played over pre-determined landscapes.
Typically, the landscape would be urban in order to appeal to the parkour enthusiasts, but could also be rural, jungle, mountainous, treacherous etc.

The game can be played with any number of people from 2 upwards (or 1 person against the computer's own avatar), but the optimum number is 4-8 players per game (either playing through the same console or gaining remote access through a game website; or the game, possibly with individual preferences, may be local to the computer of one player, e.g. who purchased a copy of it, and made accessible to other players). A scoreboard display can be made available on each screen, throughout and/or upon request and/or at certain stages.

### The Game

At the start of the game one participant is randomly selected to be ‘The Tag’ (i.e. the ‘chaser’), or perhaps the computer's own avatar will take the position as the initial ‘Tag’. His avatar will glow to indicate that he is ‘The Tag’ and his ‘Tag Time’ will begin counting while all of the other players' Tag Times' remain paused on zero.

The player (or computer avatar) selected as ‘The Tag’ is required to ‘tag’ any other player as quickly as possible by chasing them over the landscape and simply touching (or ‘tagging’) them.

When ‘The Tag’ successfully ‘tags’ a player, his ‘Tag Time’ is paused and the newly ‘tagged’ player's ‘Tag Time’ begins counting. The new player, who is now ‘The Tag’, chases all or any of the other players until he, in turn, touches or ‘tags’ another player, and ‘the tag’ is again transferred.

‘The Tag’ cannot ‘tag’ the player that he previously received the ‘tag’ from for a short, pre-determined interval (i.e. period of time, e.g. substantially 3, 2, 1, ½ or ¼ seconds, as desired).
The purpose of this rule to allow the ‘Evader’ time to get away from the player that he had just made ‘The Tag’, thus keeping the game more free-flowing.

### Bonus Points

Bonus points may be gained through ‘Style Manoeuvres’ (predefined manoeuvres for which there are predefined respective numbers of bonus points) while traversing obstacles, e.g. running, jumping or climbing over, under or through obstacles such as walls, rails, staircases, park benches, parked cars, pipes, low arches. The ‘Style Manoeuvre’ bonus points can be achieved when a player is either ‘The Tag’ or an ‘Evader’.

Bonus points are used to offset the ‘Tag Time’—In other words, the more bonus points that a player achieves, the more he reduces his ‘Tag Time’.

In order to keep the game exciting, the following limitation may be added to the rules built into the program. A player will only be awarded ‘Style Manoeuvre’ points if ‘The Tag’ is within a certain predefined proximity to the player, which may defined as appearing in the same frame (i.e. screen-shot) as the player. This stops somebody winning by just hiding and carrying out loads of ‘Style Manoeuvres.’ Obviously, if a player is ‘The Tag’ himself then he/she is continuously eligible for ‘Style Manoeuvre’ points.

Additional points may be achieved every time a player successfully ‘tags’ another player. This is called a ‘Tag Bonus’.
Note: the ‘Tag Bonus’ is a risky strategy, but one designed to make the game more interesting. It is in a player's interest to get ‘Tagged’ and become ‘The Tag’ so that he could ‘Tag’ someone else and gain the ‘Tag Bonus’. However, if he is not able successfully to ‘tag’ another player within a particular period of time (a time threshold), his increased ‘Tag Time’ will outweigh any advantage that he gained from the ‘Tag Bonus’.

The game continues for a pre-determined amount of time and at the end of the game the player with the lowest ‘Tag Time’ wins.

The foregoing assumes that the score evaluation is linear with total time tagged, e.g. one point per second, but could be non-linear.

### Variations

### Last Man Standing—

The computer avatar starts as ‘The Tag’ and when he/she touches or ‘Tags’ another player they will also become ‘The Tag’ IN ADDITION to the original ‘Tag’. The winner is the last player to get ‘Tagged’. However, this can be combined with a feature of the score evaluation being also dependent upon timing as further described herein.

### Other Details

### Character Skillset—

In order to evade ‘The Tag’, on-screen avatars will have to climb walls, jump over obstacles and rooftops, and generally be agile, fast, and/or strong, and/or have other skills.

When choosing an avatar to represent them in the game, a player must decide which predetermined set of skills and abilities he feels are important as each avatar will have a different skillset. Alternatively, there may be used a method involving skill to choose a skillset, or random allotment.
The following list is not exhaustive but the skillsets likely to be represented include—speed, acceleration, agility, upper body strength (climbing ability), balance, jump ability, toughness (i.e. recovers quickly after a bad fall), airtime awareness (good for getting ‘Style Manoeuvre’ bonus points), fitness (begins to tire if pushed too hard).

### Cheating

To make the game more interesting players may be allowed to have the ability to cheat. For example, there will be a computer controlled Avatar who is also the referee and who continuously follows whichever player is ‘The Tag.’
When out of the line of sight of the referee, players can purposely punch, kick, trip or otherwise further inhibit the movement of their competitors in order to slow them down and make them more susceptible to getting caught by ‘The Tag’, the referee and players here being avatars.
The ‘Character Skillset’ becomes relevant in the player's ability to punch or kick other competitors and also in a player's ability to recover after they have been attacked by another competitor/competitors.
If however a player is observed by the referee while attacking another competitor, he/she will be punished with a penalty, e.g. a ‘Time Penalty.’ For example, the ‘Time Penalty’ may be predefined to be anything between 10-60 seconds.

### PARTICULAR DESCRIPTION OF EMBODIMENTS

Reference will now be made by way of example to the accompanying drawings, in which:

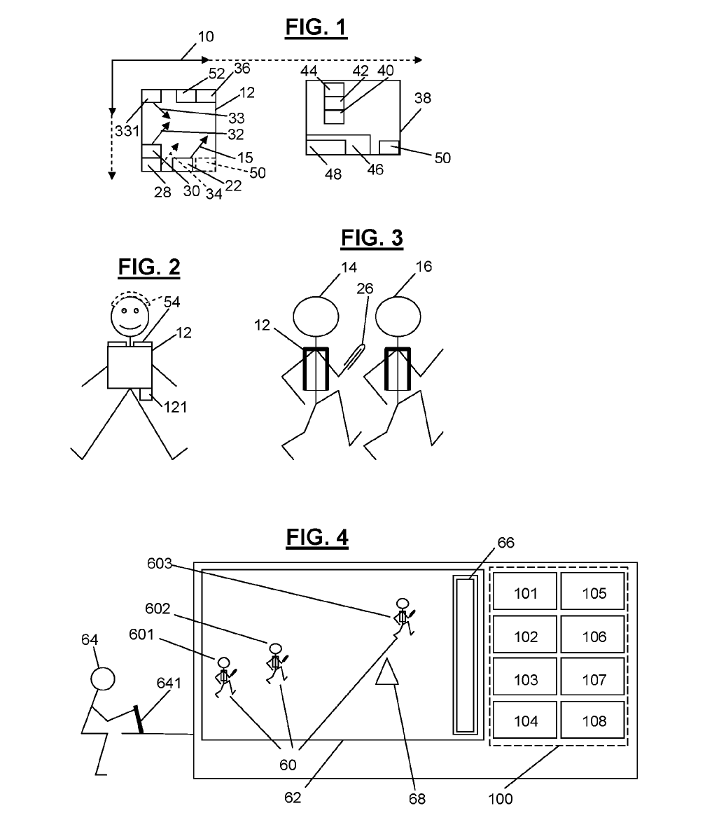

FIG. 1 is a schematic diagram of first and second embodiments of the invention, without and with a central unit 38, respectively;

FIG. 2 is a front view schematic diagram of a player wearing a first embodiment of the invention;

FIG. 3 is a side view schematic diagram of two such players, the back one about to touch the front one and transfer the tag to him;

FIG. 4 is a diagrammatic view of apparatus embodying a computerised game version of the invention;

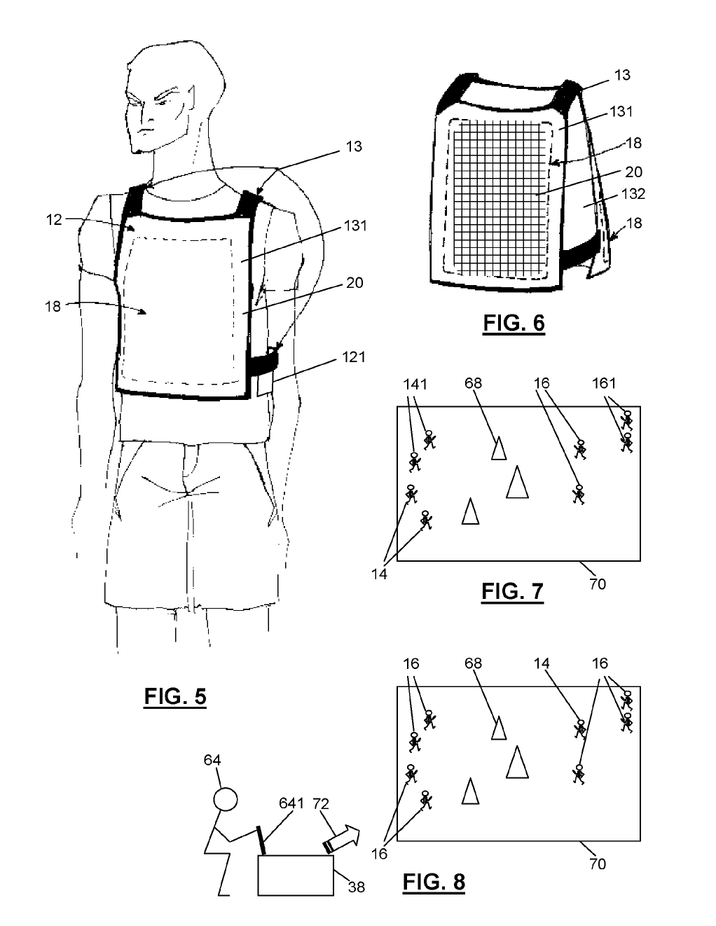

FIG. 5 is a front view of a player wearing the first embodiment of the invention;

FIG. 6 is a front perspective view of the first embodiment of the invention;

FIG. 7 is a schematic plan view of a field set up for manhunt in accordance with an embodiment of the invention; and

FIG. 8 is a schematic view of another embodiment of the invention comprising physical avatars (robots) on a field (shown in schematic plan view), each controlled as to position and/or action by a corresponding player (shown in schematic side view).

Referring to the drawings, identical references refer to the same item in the same Figure or different Figures or items that are identical or similar or have similar functions, and references with the same first two digits (or same first three digits) refer to items that are identical or similar or related or have similar or related functions.

Means 10 to enable scoring in a game of tag in dependence upon the time duration that a player remains Tag comprise means 12 constructed and arranged to detect the occurrence of a tagging event, being defined as an event at which tag passes from a first player 14 who is Tag until the event to a second player 16 who thereupon becomes Tag instead, and provide a signal 15 to indicate the detection. The signal 15 may be stored, together with the time of occurrence of the event, in a memory 36 carried by each player 14, 16 and/or may be transmitted to a memory 36 in central unit 38, described below. The means 12 to detect when a tagging event occurs comprise an article of wear 12 which is touch-sensitive and in this embodiment comprises a touch-sensitive bib 12, fastened in place by straps 13 interconnecting front and back parts 131, 132. The bib 12 of the second player 16 (just as for each other player) may have any suitable means 18 to sense when it is touched by the first player 14. For example, means 18 may be a touch-sensitive pad 18 that comprises a mosaic of independent small elements 20, e.g. piezoelectric elements, each of which is adapted to generate a current when touched, the bib 12 having means 22 connected to receive and detect any such current and thereupon generate the signal 15. Again, the small elements 20 may be such that adjacent elements 20 are of different electric potentials, or possibly of opposite electric polarity, such that touching two adjacent elements produces an electrical connection between them that causes a current to flow, again detected by means 22 to generate signal 15. For this purpose, player 14 is preferably provided with electrically conductive gloves 26. This alternative has the advantage that if player 16 accidentally touches a non-conductive object, e.g. a wall, no signal 15 will be generated. Again, to reduce or eradicate the possibility of a signal 15 being generated falsely, there may be proximity means 28 carried by each player, e.g. second player 16, adapted to cooperate with ID means 30 carried by each player, e.g. first player 14, and arranged to inhibit generation of the signal 15 unless simultaneously detecting a signal from a proximate ID means 30 carried by another player. Thus, generation of the signal 15 indicates a valid touching (i.e. tagging) event. Such ID means 30 can be very simple and indicate the same ID for all players, unless required to identify each player, e.g. to identify the players 14, 16 being the old Tag and the new Tag.

(Even without proximity means 28, ID means 30 of a touched player 16 may produce an ID signal 32 specifically indicative of that player and this signal 32 may be associated with the signal 15, and possibly with a timing signal 33 (from a timing means 331) indicating the time at which the tagging event took place.)

However, if the ID means 30 are distinctive of every player, or at least of the team identity of a player if the players are in designated teams, the proximity means 28 of a touched player 16 can be adapted to produce a signal 34 indicative of the distinctive ID (due to its distinctive signal 32) of the other player 14, the touching (previous) Tag.

Another possibility is to provide each player with a signal generator and receiver 28, which may be part of or replace proximity means 28, which generates one signal, say continuous 11 kHz, while a player (say, 14) is Tag and another signal, say continuous 10 kHz, when the player (say, 16) is not Tag. The bib 12 is electrically conductive. The output from signal generator 28 for each player 14, 16 is fed as an electrical signal to his bib 12. When Tag player 14 touches the bib 12 of not-Tag player 16, the receiver 28 of each player 14, 16 receives a combination of the two signals (i.e. a dual signal) and switches over its generator 28 to produce the other signal. This changeover upon touching is detected and used to terminate the Tag period for player 14 and to initiate a Tag period for player 16. Means included in receiver 28 can be used to obviate hunting, when Tag would pass from one player to the other repeatedly throughout the duration of a touching, e.g. a time delay of e.g. 5 seconds to allow a touch to be terminated before changing over the signals, or e.g. a delay in the changeover until the dual signal is no longer detected, which indicates that the touching has ceased. In such a case, it could be useful to enable a response immediately upon detecting the dual signal and before the changeover, e.g. by issuing a signal to indicate to either or each player that there has in fact been a touching. It will be in the Tag player's interest to terminate the touching as soon as possible, so as to minimise his time as Tag.

All of the equipment thus far described, being part of means 10 to enable scoring, could be carried by each player, as indicated, and produce a record in a recording means 36 carried by each player. At the end of a game, e.g. after a designated time, e.g. five minutes, the records of the different players can be collected and consolidated (aggregated) to determine the times at which each player became Tag and the duration that each such tag lasted, to enable a scoring to be evaluated as indicated above.

More conveniently (and interestingly, from the point of view of making this a spectator sport), the equipment 10 comprises a central unit 38, to which the signals 32 and 34 can be transmitted, that has central recording means 40 arranged to act in real time to record the time or times at which each player became Tag in conjunction with the ID of that player, possibly with a calculator 42 to perform a time subtraction between the time a player became Tag and the time that player succeeded in passing on the tag (or the time that another player became Tag, which would have the same effect but could be ascertained by different logical circuitry), possibly together with evaluation means 44 to evaluate a score for each player to include any non-linear dependence of score on time and/or to include any special points award (positive or negative) due to style manoeuvres or other point-scoring actions of a player, possibly in conjunction with display means 46, which preferably is arranged to present a running display 48 of the current score of each player, e.g. side-by-side for all the players.

Further to improve the game, as indicated above, means 50 which may be carried by the individual players or may preferably be arranged at the central unit 38, are constructed and arranged to make use of player-ID information signals as aforesaid to ensure a predetermined minimum interval before a newly tagged player can pass tag back to the previous player who tagged them.

Calculator 42 may also comprise means constructed and arranged to aggregate the times and/or scoring evaluations for a player or team.

The use of a central unit 38 presupposes means 52 constructed and arranged to transmit information denoting any such detection, time duration, score, aggregate, ID and/or tagging event, as the case may be. Such means 52 may be active and carried by each player, or again each player may have a device like an RFID device 52 which is passive and contains up-to-date information for the player carrying it and is interrogated (or read) at frequent intervals by the central unit 38, which does this in addition to serving as a central receiving means 38 adapted to receive such information.

As indicated, the central unit 38 preferably comprises a central processing means comprising calculator 42 and evaluation means 44 adapted to process such information, as well as display means 46 constructed and arranged to display by means of a running display 48 an indication of at least the players who have been tagged and the tagging score of each of them, and preferably also constructed and arranged to display the aggregates in a list in order of magnitude, preferably in order from lowest to highest.

Again, with a view to making this more interesting as a spectator sport, and also perhaps making it easier to play, the equipment 10 is provided with means 54, e.g. visual, e.g. LED means, to indicate which player is Tag, perhaps a cap or shoulder mounts 54 with a light, e.g. on top.

The signal units 36, 52, 331, 30, 28, 22 and 50 of bib 12 are contained in a control unit 121 fixed to a waist belt 13 of bib 12.

It will be seen that embodiments of the invention can provide a modified game of tag in which a score is made in dependence upon the time that a player is tag and provide means to enable scoring to put this into effect. As described above, the game preferably is made dependent also upon one or more defined features of skill exhibited by the Tag (or a player evading the Tag).

As also indicated above, there can be a computerised form of the game. This requires equipment and/or a computer programme for simulating a game of Tag comprising programme means 100 adapted and/or arranged:
with an element 101 to provide a plurality of avatars 60 on a screen 62 and movable under the control of respective players 64 of the game via control means 641, and a number of obstacles 68, normally fixed but possibly movable or having controllable positions,
with an element 102 to designate, or enable, initially one of the avatars 60 as Tag 601,
with an element 103 arranged so as, when a Tag 602 touches another avatar 603, to transfer the Tag designation to the latter, and
with an element 104 to evaluate a score dependent upon the time an avatar 60 is Tag.

The programme means 100 preferably comprises:
an element 105 adapted and/or arranged to aggregate the time evaluations for an avatar 60;
a program element 106 adapted and/or arranged to display the aggregates in an ordered list 66, preferably in order from lowest to highest;
a program element 107 adapted and/or arranged to provide or associate a plurality of said avatars 60 with skill sets (which may differ from one avatar to another); and
a program element 108 adapted and/or arranged to evaluate a said score dependent also upon one or more defined features of skill.

Thus, there can be provided equipment and/or a computer programme for simulating a game being a modified game of tag, as indicated above, adapted to provide a plurality of avatars 60 on a screen 62 representing players 64 of the game, adapted to respond to control means 641 to move the avatars 60 on the screen 62, adapted to ascertain when a designated one of the avatars 60 (herein called the Tag) touches another and thereby transfers the tag to the other, and adapted to time, or otherwise evaluate a score depending upon, the duration that one avatar is Tag until transferring the tag to another avatar.

Referring to FIG. 7, a field 70 is set up to play manhunt as described above in an embodiment of the invention, with a team of (Tag) hunters 14 and a team of hunted players 16. At the stage shown, two players 141 of the hunters 14 are Tags while the other hunters 14 are not yet in the game, and two players 161 of the hunted players 16 have been touched by players 141 and hence knocked out of the game. The game has been paused at the last touching and the players 14 and 16 have moved to their designated locations, as shown, and the game is just about to be re-commenced.

Referring to FIG. 8, another group of embodiments of the invention comprises physical avatars (robots) 14, 16 on a field 70 each controlled as to position and/or action by a corresponding player 64 by means of a control stick 641 on one or more control units 38 via non-wired signals 72. The method of play and required apparatus are otherwise as for any of the previously described embodiments.

In a simple embodiment, the apparatus 12 carried by a player 16, is e.g. a tunic with one or more touchable buttons arranged to respond to being touched to operate a signal generator 22 of the apparatus to cause the apparatus to generate and transmit a multiplex-type signal 15 that contains one element which is the player's ID and another which is possibly the timestamp. The central unit 38 receives such signals in succession. It has a differencer (part of calculator 42) which subtracts the last previously received signal's timestamp from the currently received signal's timestamp to provide a value which is a measure of the length of the period for which the previous player 14, i.e. the player whose apparatus 12 transmitted the previous signal 15, continued to have the status of tag after that signal's timestamp. The central unit 38 has a register, counter or other aggregator (part of calculator 42) for each player, to which it feeds all such values for the relevant player identified by the ID to aggregate those relevant values for that player. The central unit 38 also has a display 46 connected to the aggregators 42 that displays a bar for each player, such that the length of each bar increases in accordance with each such value received by the aggregator, preferably on a current-time basis. This apparatus 12 can be applied to a game in which the players on a playing field 70 are real people 14, 16, or to a game in which the players 14, 16, FIG. 7, on a playing field 70 are on-screen avatars controlled by players 64 who are real people, or to a game in which the players 14, 16, FIG. 8, on a playing field 70 are physical avatars (e.g. remotely controlled robots) controlled by players 64 who are real people. It is to be understood that the items 38, 72, 64, 641 shown in FIG. 8 are also present in the FIG. 7 embodiment, though omitted from the drawing for the sake of clarity.

It will be apparent, to one skilled in the art, that features of the different embodiments disclosed herein may be omitted, selected, combined or exchanged and the invention is considered to extend to any new and inventive combination thus formed. Where a preference or particularisation is stated, there is implied the possibility of its negative, i.e. a case in which that preference or particularisation is absent.

Many variations of the invention and embodiments hereinbefore described will be apparent to people skilled in the art and all such variations are to be considered as falling within the scope of the invention.

1.-21. (canceled)

22. Apparatus for use in a game of tag, comprising timing means responsive to a first touching by a first player of a second player to determine a time for said first touching and responsive to a second touching by the second player of another player to determine a time for said second touching, the apparatus comprising association means constructed and arranged to associate the two determinations to enable the determination of a value which is the length of the period between said first and second touchings or is a quantity dependent on such length.

23. Apparatus as claimed in claim 22, comprising aggregating means constructed and arranged to aggregate said values for a player.

24. Apparatus as claimed in claim 23, comprising display means constructed and arranged to display such values and/or aggregates as the case may be for a plurality of players in association with IDs of the respective players and/or IDs of a plurality of teams comprising the players.

25. Apparatus as claimed in claim 22, comprising an article of wear responsive to a said touching.

26. Apparatus as claimed in claim 22, comprising proximity means constructed and arranged to be carried by a player and adapted to detect that another player is proximate when a said touching occurs.

27. Apparatus as claimed in claim 22, comprising validation means constructed and arranged to determine whether said other player is said first player and if so whether there has been a predetermined minimum interval between said first and second touchings and only if so to validate said second touching for determining said value.

28. Apparatus as claimed in claim 22, comprising skill means to define and detect features of skill exhibited by a said player, said association means being adapted for the said quantity to be dependent also upon one or more of these defined features.

29. Apparatus for use in a game of tag between player-controlled avatars, comprising timing means responsive to a first touching by a first player's avatar of a second player's avatar to determine a time for said first touching and responsive to a second touching by the second player's avatar of another player's avatar to determine a time for said second touching, the apparatus comprising association means constructed and arranged to associate the two determinations to enable the determination of a value which is the length of the period between said first and second touchings or is a quantity dependent on such length.

30. Apparatus as claimed in claim 29, comprising means constructed and arranged to aggregate said values for a player's avatar.

31. Apparatus as claimed in claim 30, comprising display means constructed and arranged to display such values and/or aggregates as the case may be for a plurality of players' avatars in association with the IDs of the respective players' avatars and/or IDs of a plurality of teams comprising the players' avatars.

32. Apparatus as claimed in claim 29, comprising validation means constructed and arranged to determine whether said other player's avatar is said first player's avatar and if so whether there has been a predetermined minimum interval between said first and second touchings and only if so to validate said second touching for determining said value.

33. Apparatus as claimed in claim 29, comprising skill means to define and detect features of skill exhibited by a said player's avatar, said association means being adapted for the said quantity to be dependent also upon one or more of these defined features.

34. A computer program or programming means, adapted to program computerised apparatus to operate as apparatus as claimed in claim 29.

35. A modified game of tag in which a first player touches a second player to transfer tag status thereto and the second player touches another player to transfer tag status thereto and a score is made in dependence upon the length of time said second player remains tag between the two touchings.

36. A game as claimed in claim 35, in which an aggregate is made of said scores for a said player.
